(19) United States
(12) Patent Application Publication
(10) Pub. No.: US 2025/0378235 A1
(43) Pub. Date: Dec. 11, 2025

(54) APPARATUS AND METHOD FOR PERFORMING PROCESS SIMULATION OF SEMICONDUCTOR DEVICES

(71) Applicant: Samsung Electronics Co., Ltd., Suwon-si (KR)

(72) Inventors: Sanghoon MYUNG, Suwon-si (KR); Kyeyeop KIM, Suwon-si (KR); Jinwoo KIM, Suwon-si (KR); Chanyoung LEE, Suwon-si (KR); Beomwon JUNG, Suwon-si (KR); Gijae KANG, Suwon-si (KR); Jaehoon JEONG, Suwon-si (KR); Yunji CHOI, Suwon-si (KR); Songyi HAN, Suwon-si (KR)

(73) Assignee: Samsung Electronics Co., Ltd., Suwon-si (KR)

(21) Appl. No.: 19/024,261

(22) Filed: Jan. 16, 2025

(30) Foreign Application Priority Data
Jun. 11, 2024 (KR) 10-2024-0075820

(51) Int. Cl. G06F 30/27; G06F 111/02

(52) U.S. Cl. CPC G06F 30/27; G06F 2111/02

(57) ABSTRACT

Provided are an apparatus and method for generating a wafer map corresponding to coordinates of a wafer by using a distribution model. A method of performing a process simulation of a semiconductor device includes computing reaction of input data by using a plasma model, and based on the computed reaction, generating a first output including first flux and first energy, generating a second output including second flux and second energy, based on the first output and coordinates of a wafer, by using a distribution model, and generating a wafer map based on the second output and a structure of the wafer by using an etch model, wherein the second flux includes flux corresponding to each of the coordinates of the wafer, and wherein the second energy includes energy corresponding to each of the coordinates of the wafer.

### CROSS-REFERENCE TO RELATED APPLICATION

This application is based on and claims ranking under 35 U.S.C. § 119 to Korean Patent Application No. 10-2024-0075820 filed on Jun. 11, 2024 in the Korean Intellectual Property office, the disclosures of which are incorporated by reference herein in their entirety.

### BACKGROUND

Inventive concepts relate to a process simulation of semiconductor devices, and more specifically, to an apparatus and/or method for generating a wafer map corresponding to the coordinates of the wafer by using a distribution model.

As semiconductors become highly integrated and refined, factors at each process of designing and manufacturing semiconductor devices may act in combination, and accordingly, various unintended electrical characteristics may occur in semiconductor devices. As a result, the semiconductor industry's desire for a technology computer aided design (TCAD) process-device simulation environment based on physical simulation is increasing to overcome or improve upon the limitations of semiconductor processes and/or devices, in understand the phenomenon, and/or reduce experimental costs. Alternatively or additionally, to provide more accurate product specifications of semiconductor devices, it is necessary or desirable to predict and simulate the characteristics of semiconductor devices.

Particularly, in the etching process, there may be an issue of etching into a structure that is different from expected due to the influence of equipment and/or of patterns in the wafer. Accordingly, there may be a desire for a method and/or an apparatus capable of modeling how the distribution of gases in a wafer is formed in response to the coordinates of the wafer, and then setting input data to a combination in which the distribution of gases is least.

### SUMMARY

Various example embodiments provide a method and/or apparatus for generating a distribution model based on measured critical dimensions (CDs) in a wafer, and generating a wafer map corresponding to coordinates of the wafer by using the distribution model.

According to some example embodiments, there is provided a method of performing a process simulation of a semiconductor device including computing reaction of input data by using a plasma model, and based on the computed reaction, generating a first output including first flux and first energy, generating a second output including second flux and second energy, based on the first output and coordinates of a wafer by using a distribution model, and generating a wafer map based on the second output and a structure of the wafer by using an etch model. The second flux includes flux corresponding to each of the coordinates of the wafer, and the second energy includes energy corresponding to each of the coordinates of the wafer.

Alternatively or additionally according to some example embodiments, there is provided a system including at least one processor, and a non-transitory storage medium storing computer-readable instructions, that when executed by the at least one processor, cause the system to perform a method of performing a process simulation of a semiconductor device. The method of performing the process simulation of the semiconductor device includes outputting first flux and first energy, the first flux and first energy based on a reaction of input data including gas, temperature, and a voltage, outputting second flux and second energy corresponding to the coordinates of the wafer, the second flux and second energy based on the first flux, the first energy, and the coordinates of the wafer, the outputting of the second flux and second energy by using a distribution model, and generating a wafer map based on the second flux, the second energy, and a structure of the wafer by using an etch model. The wafer map includes critical dimensions (CDs) corresponding to a distribution of the second flux, a distribution of the second energy, and the coordinates of the wafer.

Alternatively or additionally according to various example embodiments, there is provided a non-transitory computer-readable recording medium storing instructions, wherein the instructions are configured such that, when executed by the at least one processor, cause the at least one processor to execute a method of performing a process simulation of a semiconductor device. The method of performing the process simulation of the semiconductor device includes outputting first flux and first energy, the first flux and first energy based on a reaction of input data including gas, temperature, and a voltage, outputting second flux and second energy, the second flux and second energy corresponding to coordinates of the wafer, the outputting the second flux and second energy based on the first flux, the first energy, and the coordinates of the wafer, the outputting the second flux and second energy by using a distribution model, and generating a wafer map based on the second flux, the second energy, and a structure of the wafer by using an etch model. The wafer map includes critical dimensions (CDs) corresponding to a distribution of the second flux, a distribution of the second energy, and the coordinates of the wafer.

### BRIEF DESCRIPTION OF THE DRAWINGS

For better understanding of the drawings cited in the detailed descriptions of the inventive concept, a brief description of each drawing is provided.

Some example embodiments will be more clearly understood from the following detailed description taken in conjunction with the accompanying drawings in which:

FIG. 1 is a block diagram of a system for performing a process simulation of a semiconductor device, according to some example embodiments;

FIG. 2 is a flowchart of a method of performing a process simulation of a semiconductor device, according to some example embodiments;

FIG. 3 is diagrams illustrating coordinates of wafers, according to some example embodiments;

FIG. 4 is a diagram of a wafer map according to some example embodiments;

FIG. 5 illustrate diagrams of wafer maps according to some example embodiments;

FIG. 6 is a flowchart of a method of generating a distribution model, according to some example embodiments;

FIG. 7 is a diagram of a pre-measured critical dimensions (CDs) in a wafer for generating a distribution model, according to some example embodiments;

FIG. 8 is a flowchart of a method of training a distribution model, according to some example embodiments;

FIG. 9 is a flowchart of a method of performing a process simulation of a semiconductor device, according to some example embodiments;

FIG. 10 illustrates diagrams of quantified wafer maps according to some example embodiments;

FIG. 11 is a diagram of a quantified wafer map according to some example embodiments;

FIG. 12 is a block diagram of a computer system according to some example embodiments; and

FIG. 13 is a block diagram of a system according to some example embodiments.

### DETAILED DESCRIPTION OF EXAMPLE EMBODIMENTS

Hereinafter, some example embodiments of the inventive concept are described clearly and in detail so that one of ordinary skill in the art easily implements the inventive concept.

In inventive concepts, a “machine learning model” may have an arbitrary structure capable of training. For example, the machine learning model may include an artificial neural network, a decision tree, a support vector machine, a Bayesian network, and/or a genetic algorithm, etc. Hereinafter, the machine learning model is to be described mainly with reference to an artificial neural network, but example embodiments of inventive concepts are not limited thereto. The artificial neural network may include, as a non-limiting example, one or more of a convolution neural network (CNN), a region with convolution neural network (R-CNN), a region proposal network (RPN), a recurrent neural network (RNN), a stacking(S)-based deep neural network (DNN) (S-DNN), a state(S)-space(S) DNN (S-SDNN), a deconvolution network, a deep belief network (DBN), a fully convolutional network, a long short-term memory (LSTM) network, a classification network, etc. In inventive concepts, the machine learning model may also be simply referred to as a model.

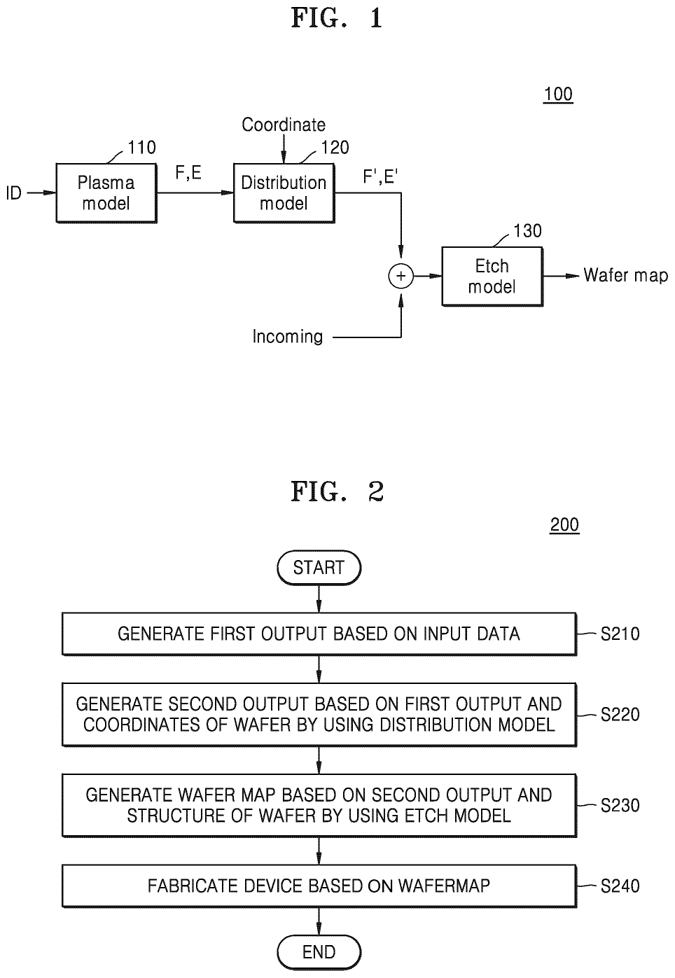

FIG. 1 is a block diagram of a system 100 for performing a process simulation of a semiconductor device, according to some example embodiments.

Although FIG. 1 briefly illustrates the system 100 for performing a process simulation of a semiconductor device to describe the technical idea of inventive concepts, the technical idea of inventive concepts is not limited thereto. For example, the system 100 may include at least one processor and a non-transitory storage medium storing machine-readable instructions, that, when executed by the at least one processor, cause the system to perform a method of performing process simulation of a semiconductor device.

Hereinafter, various operations executed by the at least one processor may be directly implemented as hardware, a software module executed by the at least one processor, or a combination thereof. When implemented as a software module, functions thereof may be stored as one or more instructions or code in a tangible non-transitory storage medium. The software module may be included in one or more of random access memory (RAM), flash memory, read-only memory (ROM), electrically programmable ROM (EPROM), electrically erasable and programmable ROM (EEPROM), a register, a hard disk, a mobile disk, a compact disk (CD) ROM, or other arbitrary types of storage media.

Referring to FIG. 1, the system 100 may include a plasma model 110, a distribution model 120, and an etch model 130. The plasma model 110 may receive input data ID to compute a reaction of the input data ID, and based on the computer reaction, may generate a first output including first flux F and first energy E. In some example embodiments, the plasma model 110 may receive the input data ID from the outside; however, example embodiments are not limited thereto. For example, the system 100 may receive the input data ID from a user via a user interface (not illustrated).

In some example embodiments, the input data ID may include any one or more of gas, power (or voltage), time and temperature. The first flux F may indicate an amount of ions and/or radicals in a wafer according to the reaction of the gas computed by the plasma model 110 and based on the input data ID. An ion may indicate a state in which one or more electrons are lost or obtained from an otherwise neutral atom. A radical may indicate an independently present chemical species with non-covalent hole electrons, and may be relatively unstable and have high reactivity. The first energy E may indicate the speed, e.g., the collision speed, of ions and/or radicals in a wafer.

In some example embodiments, the plasma model 110 may be configured as a physical simulation and/or as machine learning model. For example, the plasma model 110 may be configured as a technology computer aided design (TCAD) process-device simulation and/or a machine learning model which has learned data of the TCAD process-device simulation. However, the technical idea of inventive concepts is not limited thereto.

The distribution model 120 may generate a second output including second flux F′ and second energy E′, based on the first flux F, the first energy E, and the coordinates of the wafer. In some example embodiments, the distribution model 120 may receive a first output including the first flux F and the first energy E that are generated by the plasma model 110.

In some example embodiments, the coordinates of the wafer may include coordinates corresponding to a cartesian coordinate system and/or coordinates corresponding to a polar coordinate system, e.g., with respect to a center of the wafer and/or with respect to a notch or flat of the wafer. The second flux F′ may indicate flux corresponding to each of the coordinates of the wafer, and the second energy E′ may indicate energy corresponding to each of the coordinates of the wafer. For example, the second flux F′ may indicate an amount of ions and/or radicals corresponding to each of the coordinates of the wafer, and the second energy E′ may indicate speeds of ions and/or radicals corresponding to each of the coordinates of the wafer.

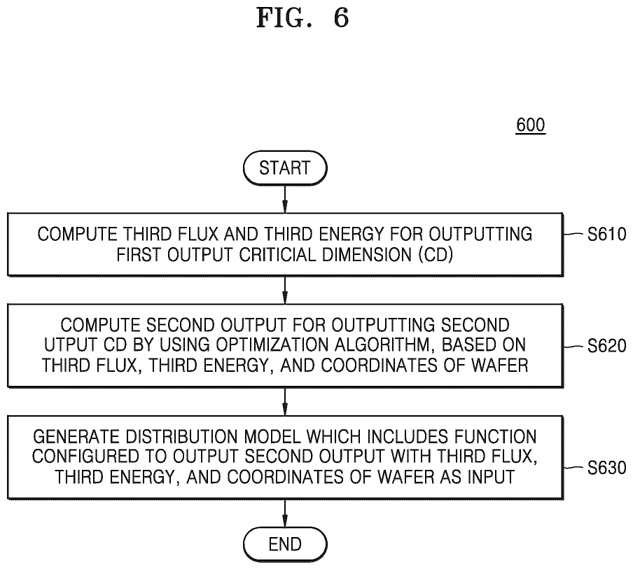

In some example embodiments, the distribution model 120 may be generated as a physical simulation or a machine learning model. Some example embodiments in which the distribution model 120 is generated is described below with reference to FIGS. 6 through 8.

The etch model 130 may generate the wafer map based on the second flux F′, the second energy E′, and an incoming wafer structure. In some example embodiments, the etch model 130 may receive the second output including the second flux F′ and the second energy E′ that are generated by the distribution model 120.

In some example embodiments, the incoming wafer structure may indicate a structure at a particular location in the wafer (for example, a structure at a location to be etched). For example, the incoming wafer structure may indicate a structure at a particular location in the wafer corresponding to the coordinates of the wafer used by the distribution model 120 when generating the second output.

In some example embodiments, the wafer map may include a distribution of the second flux F′, a distribution of the second energy E′, and critical dimensions (CDs) respectively corresponding to the coordinates of the wafer. For example, the wafer map may include a positive distribution (or scattering deviation) of ions and/or radicals corresponding to the coordinates of the wafer, a distribution (or scattering deviation) of the speed of ions and/or radicals corresponding to the coordinates of the wafer, and a distribution (or scattering deviation) of the CDs respectively corresponding to the coordinates of the wafer. However, the technical idea of inventive concepts is not limited thereto. For example, the system 100 may generate the wafer map including the distribution of the second flux F′ and the distribution of the second energy E′, based on the second output of the distribution model 120.

In some example embodiments, the etch model 130 may be configured as a physical simulation and/or as a machine learning model. For example, the etch model 130 may include the TCAD process-device simulation and/or a machine learning model which have learned data from the TCAD process-device simulation. However, the technical idea of inventive concepts is not limited thereto.

The system 100 according to inventive concepts may use the distribution model 120 to generate the wafer map which includes a distribution of the amount of ions and/or radicals corresponding to the coordinates of the wafer, a distribution of speeds of ions and/or radicals corresponding to the coordinates of the wafer, and a distribution of CDs corresponding to the coordinates of the wafer, and may perform modeling of distribution dispersion occurring at each location of the wafer (for example, one or more of an imbalance of CDs or imbalances of ions and/or radicals in the wafer). Thus, by changing the input data ID, distribution dispersion occurring due to a location in a wafer may be reduced or improved upon. There may be an improved process of fabricating a semiconductor device according to some example embodiments. For example, there may be one or more of an improved yield, an improved fabrication time, or an improved reliability according to some example embodiments, by reducing a distribution dispersion.

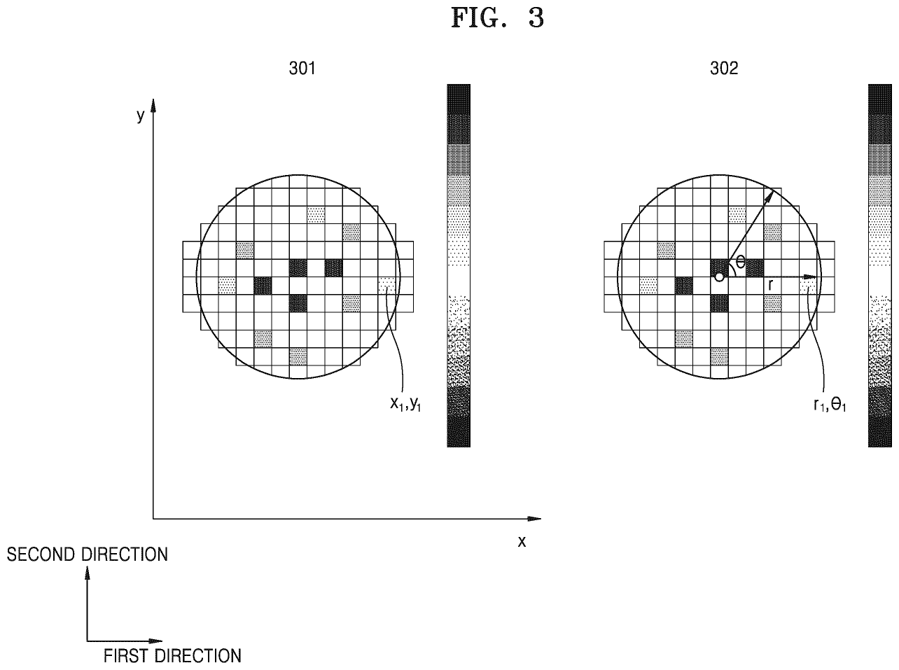

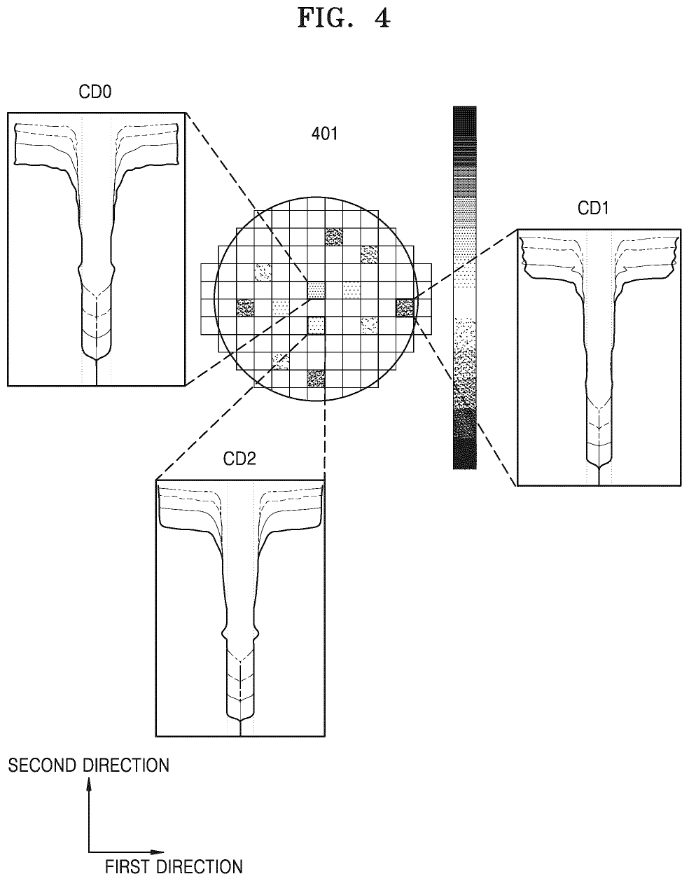

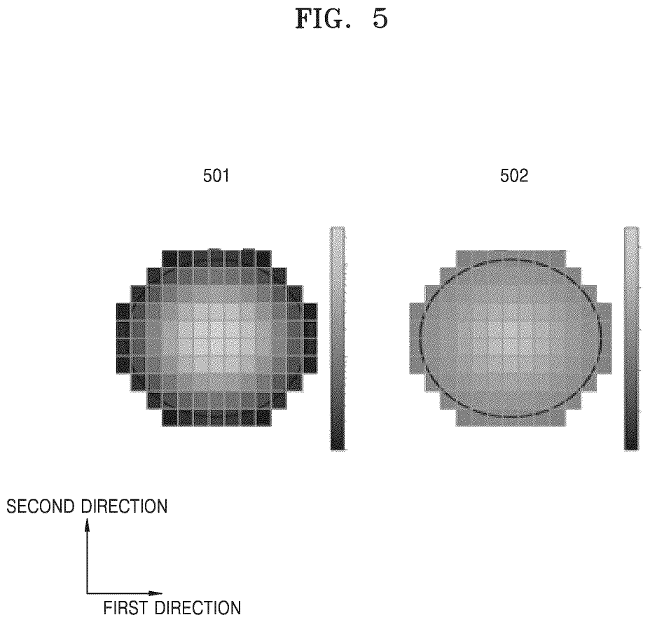

FIG. 2 is a flowchart of a method 200 of performing a process simulation of a semiconductor device, according to some example embodiments. FIG. 3 is a diagram illustrating coordinates of first and second wafers 301 and 302, according to some example embodiments. FIG. 4 is a diagram of a first wafer map 401 according to some example embodiments. FIG. 5 illustrates diagrams of a second wafer map 501 and a third wafer map 502 according to some example embodiments.

Referring to FIG. 2, the method 200 of performing a process simulation of a semiconductor device may include a plurality of operations S210 through S230. Referring further to FIG. 1, in operation S210, the first output may be generated based on the input data ID. In some example embodiments, the system 100 may receive the input data ID from the outside, and the input data ID may include any one or more of gas, power (and/or voltage), time, and temperature. The system 100 may calculate the reaction of the input data ID, and may generate the first output including the first flux F and the first energy E, based on the computed reaction.

In operation S220, the second output may be generated based on the first output and the coordinates of the wafer by using the distribution model 120. In some example embodiments, the distribution model 120 may generate the second output including the second flux F′ and the second energy E′, based on the first flux F, the first energy E, and the coordinates of the wafer.

In some example embodiments, the coordinates of the wafer may include either coordinates corresponding to a cartesian coordinate system or coordinates corresponding to a polar coordinate system, or both cartesian and polar coordinates. Referring further to FIG. 3, a first wafer 301 may include a wafer to which a cartesian coordinate system is applied, and a second wafer 302 may include a wafer to which a polar coordinate system is applied. Although FIG. 3 illustrates that the grid is divided into squares, example embodiments are not necessarily limited thereto. Additionally or alternatively, there may or may be notches on an edge of each wafers. Vertical axes of the first wafer 301 and the second wafer 302 may indicate relative depths of the wafer structure corresponding to the coordinates of the first wafer 301 and second wafer 302. The cartesian coordinate system may indicting a coordinate system representing a location on a plane consisting of an x-axis (for example, an axis in a first direction) and a y-axis (for example, an axis in a second direction), which are perpendicular to each other. The polar coordinate system may mean a coordinate system that represents a location on the plane by using an angle θ (for example, an angle set based on the center of the wafer) and a distance r (for example, a distance from the center of the wafer). A first location (x₁, y₁) of the first wafer 301 may have a different expression method from a second location (r₁, θ₁) of the second wafer 302, but may indicate the same location.

For example, the distribution model 120 may generate the second output including the second flux F′ and the second energy E′, based on the first flux F, the first energy E, and the first location (x₁, y₁). The second flux F′ may mean the amount of ions or radicals at the first location (x₁, y₁), and the second energy E′ may mean the speed of ions or radicals at the first location (x1, y1).

Referring to FIGS. 1 and 2 again, in operation S230, the wafer map may be generated based on the second output and the incoming wafer structure by using the etch model 130. In some example embodiments, the incoming wafer structure may mean a structure at a particular location in the wafer (for example, a structure at a location to be etched). For example, the incoming wafer structure may mean a structure of the first location (x1, y1) in FIG. 3, and may also mean a structure of a particular location in the first wafer 301 other than the first location (x1, y1) in the first wafer 301.

In some example embodiments, the wafer map may include the CD corresponding to the coordinates of the wafer. Referring further to FIG. 4, a first wafer map 401 may represent the CDs corresponding to the coordinates of the wafer, and the vertical axis of the first wafer map 401 may represent the relative depth of the wafer structure corresponding to the coordinates of the wafer. For example, the depth of the wafer structure may be relatively shallow toward the center of the wafer, and the depth of the wafer structure may be relatively deep away from the center of the wafer.

For example, the incoming wafer structure may indicate the structure at the first location (x1, y1) in FIG. 3, the second flux F′ may indicate the amount of ions and/or radicals at the first location (x1, y1) in FIG. 3, and the second energy E′ may indicate the speed of ions and/or radicals at the first location (x1, y1) in FIG. 3. The etch model 130 may generate a first CD CDI corresponding to the first location (x1, y1) in FIG. 3, based on the second flux F′, the second energy E′, and the incoming wafer structure. In addition to the first location (x1, y1) in FIG. 3, the etch model 130 may generate a zeroth CD CD0 corresponding to the center of the wafer and a second CD CD2 corresponding to the other locations in the wafer, as well as a plurality of CDs corresponding to particular locations in the wafer, and based on these CDs, may generate the first wafer map 401 representing the distribution of CDs corresponding to the coordinates of the wafer for the entire wafer.

In some example embodiments, the wafer map may include a distribution of the second flux F′ and a distribution of the second energy E′. Referring further to FIG. 5, a second wafer map 501 may represent a distribution of the amount of ions and/or radicals corresponding to each coordinate of the wafer, and the vertical axis of the second wafer map 501 may represent a relative amount of ions and/or radicals corresponding to the coordinates of the wafer. For example, the amount of ions or radicals may be relatively large toward the center of the wafer, and the amount of ions or radicals may be relatively less away from the center of the wafer.

A third wafer map 502 may represent a distribution of the speed of ions and/or radicals corresponding to each coordinate of the wafer, and the vertical axis of the third wafer map 502 may represent the relative speed of ions or radicals corresponding to the coordinates of the wafer. For example, the speed of ions or radicals may be relatively high toward the center of the wafer, and the speed of ions and/or radicals may be relatively low away from the center of the wafer.

For example, the etch model 130 may generate the second wafer map 501 representing the distribution of the amount of ions or radicals for each location of the wafer for the entire wafer, that is, the distribution of the amount of ions or radicals corresponding to the coordinates of the wafer based on the second flux F′.

For example, the etch model 130 may generate the third wafer map 502 representing the speed of ions or radicals for each location of the wafer for the entire wafer, that is, the distribution of speed of ions or radicals corresponding to the coordinates of the wafer based on the second energy E′.

Referring to FIG. 2, in some example embodiments, in operation S240 a semiconductor device may be fabricated. In some example embodiments the semiconductor device may be fabricated based on the wafer map generated in operation S230. Example embodiments are not limited thereto.

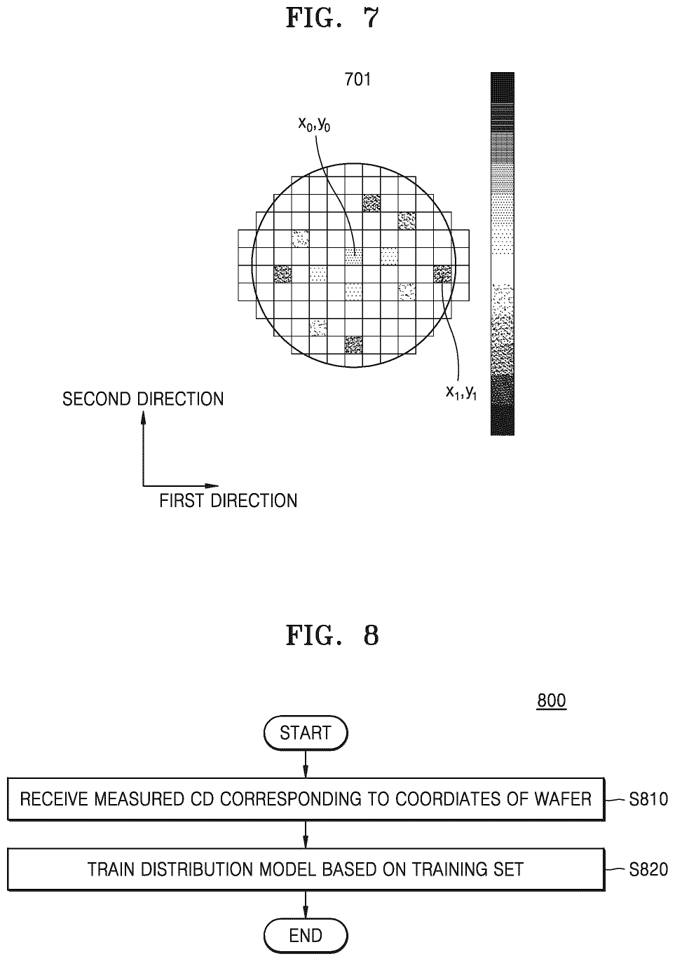

FIG. 6 is a flowchart of a method 600 of generating a distribution model, according to some example embodiments. FIG. 7 is a diagram of a pre-measured CDs in an etched wafer 701 for generating a distribution model, according to some example embodiments.

Referring to FIG. 7 first, the etched wafer 701 may include a wafer to which a cartesian coordinate system is applied, and the vertical axis of the etched wafer 701 may represent a relative depth of the wafer structure corresponding to the coordinate. The CDs corresponding to the coordinates of the wafer on the etched wafer 701 may be measured by using measurement equipment (for example, a critical dimension scanning electron microscope (CD-SEM) and/or an electrical measurement).

Referring to FIG. 6, the method 600 of generating a distribution model may include a plurality of operations S610 through S630. In some example embodiments, the method 600 of generating a distribution model may be performed before operation S220 in FIG. 2 is performed, and/or concurrently with operation S220.

Referring further to FIG. 6, in operation S610, the system 100 may compute third flux and third energy for outputting a first output CD. In some example embodiments, the first output CD may be any one or more of an average CD of the wafer and a CD corresponding to the center of the wafer, and the system 100 may use the etch model 130 to compute an input capable of outputting the first output CD, that is, the third flux and the third energy. For example, the first output CD may include a CD measured at the center (x₀, y₀) of the etched wafer 701 of FIG. 7.

In operation S620, the system 100 may use an improvement or optimization algorithm based on the third flux, the third energy, and the coordinates of the wafer, and may compute the second output for outputting a second output CD. In some example embodiments, the second output CD may mean a CD corresponding to the coordinates of the wafer. For example, the second output CD may include a CD measured at the first location (x1, y1) of the etched wafer 701 of FIG. 7 or a CD measured at a location in the etched wafer 701 of FIG. 7 other than the first location (x1, y1).

In some example embodiments, the system 100 may calculate the flux and energy for outputting the measured CD at the location in the etched wafer 701 of FIG. 7 by using an improvement/optimization algorithm based on the third flux, the third energy, and the coordinates of the wafer. The algorithm may include any one or more of a genetic algorithm and a gradient descent, but is not limited thereto. For example, the system 100 may receive the third flux, the third energy, and the coordinates of the wafer as inputs, and generate an objective function for comparing the CD based on the inputs with the second output CD. The system 100 may change the third flux and the third energy to reduce the objective function, and may set the changed third flux and the changed third energy when the objective function has a minimum value as the second output for outputting the second output CD.

In operation S630, the system 100 may generate a distribution model, which is a function configured to output the second output by using the third flux, the third energy, and the coordinates of the wafer as the inputs. In some example embodiments, the system 100 may generate a function (or a distribution model) in which the second output computed in operation S620 by using a neural network or a symbolic regression and using the third flux, the third energy, and the coordinates of the wafer as the inputs is output, but is not limited thereto.

The system 100 of inventive concepts may generate the distribution model 120 based on the measured CDs in the wafer, and may generate the wafer map corresponding to the coordinates of the wafer by using the distribution model 120. For example, the measured CDs in the wafer may include some of the entire CDs in the wafer, and the system 100 may generate the distribution model 120 by using the method 600 of generating a distribution model. The system 100 may generate the wafer map corresponding to the coordinates of the entire wafer by using the generated distribution model 120.

The CD at the center (x₀, y₀) may be different from the CD at the first position (x₁, y₁) in FIG. 7, and the distribution dispersion (for example, imbalance of CDs in the wafer) per location may be identified. The system 100 of inventive concepts may perform modelling of the distribution dispersion occurring at each location of the wafer by using the distribution model 120, and may reduce the distribution dispersion occurring at each location of the wafer by changing the input data ID.

FIG. 8 is a flowchart of a method 800 of training a distribution model, according to some example embodiments.

Referring to FIG. 8, the method 800 of training a distribution model may include a plurality of operations S810 and S820. In some example embodiments, the method 800 of generating a distribution model may be performed before operation S220 in FIG. 2 is performed.

Referring further to FIG. 1, in operation S810, the system 100 may receive the measured CD corresponding to the coordinates of the wafer. In some example embodiments, the system 100 may receive the measured CDs corresponding to the coordinates of the wafer from the user via a user interface (not illustrated), and the measured CDs may be CDs measured by using measurement equipment (for example, the CD-SEM).

In operation S820, the system 100 may train the distribution model 120, which is a machine learning model, based on a training set. The training set may include the input data ID, the coordinates of the wafer, and the measured CDs received in operation S810. In some example embodiments, the system 100 may train the distribution model 120, which is a machine learning model, based on a training set by using the plasma model 110 and the etch model 130. For example, the plasma model 110 may be expressed by Formula 1 below by applying the affine transform.

$${f}_{s} = {g}_{1} ( {f}_{s} ( {x}_{i} ) ; α ) + {g}_{2} ( {f}_{s} ( {x}_{i} ) ; β ) {g}_{3} ( c ; γ ) \qquad [ Formula 1 ]$$

In this case, fₛ may indicate the plasma model 110, and g₁, g₂, and g₃ may indicate neural network functions. α, β, and γ may indicate training parameters of an artificial neural network, xᵢ may be i^{th} input data ID among N (a natural number of 1 or more), and c may indicate the coordinates of the wafer.

The system 100 may train the distribution model 120, which is a machine learning model, by reducing the empirical risk of the artificial neural network based on Formula 1. A formula related to the empirical risk may be expressed as Formula 2 below.

$${arg min}_{α , β , γ} \frac{1}{N} {\sum }_{i = 1}^{N} ( {y}_{i} - ( {g}_{1} ( {f}_{s} ( {x}_{i} ) ; α ) + {g}_{2} ( {f}_{s} ( {x}_{i} ) ; β ) {g}_{3} ( c ; γ ) ) + {‖ α ‖}^{2} + {‖ β ‖}^{2} + {‖ γ ‖}^{2} \qquad [ Formula 2 ]$$

Here, yᵢ may mean an i^{th} measured CD among N (a natural number of 1 or more) measured CDs. When the system 100 trains the distribution model 120 based on Formula 2, the etch model 130 may be used, and when the etch model 130 is a machine learning model, the training parameters of the etch model 130 may not be changed.

The system 100 of inventive concepts may train the distribution model 120 based on the measured CDs in the wafer, and may generate the wafer map corresponding to the coordinates of the wafer by using the distribution model 120. For example, the measured CDs in the wafer may include some of the entire CDs in the wafer, and the system 100 may generate the distribution model 120 by using the method 800 of training a distribution model. The system 100 may generate the wafer map corresponding to the coordinates of the entire wafer by using the generated distribution model 120. The system 100 of inventive concepts may perform modelling of the distribution dispersion occurring at each location of the wafer by using the distribution model 120, and may reduce the distribution dispersion occurring at each location of the wafer by changing the input data ID.

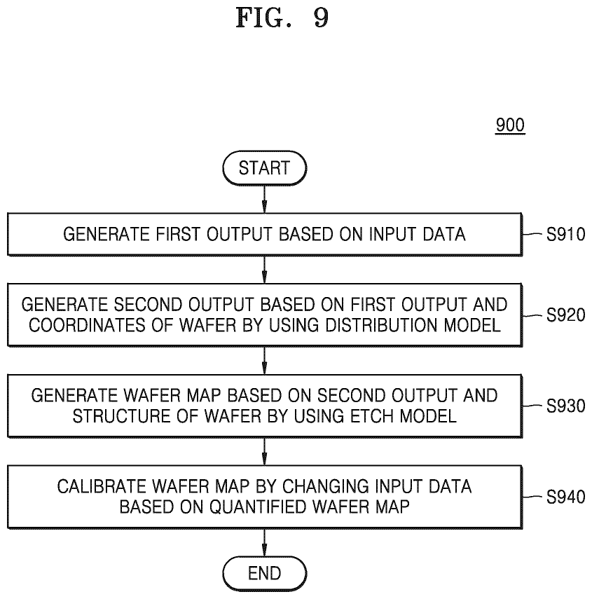

FIG. 9 is a flowchart of a method 900 of performing a process simulation of a semiconductor device, according to some example embodiments.

Referring to FIG. 9, the method 900 of performing a process simulation of a semiconductor device may include a plurality of operations S910 through S940. In some example embodiments, operations S910 through S930 may be the same as operations S210 through S230 in FIG. 2, and duplicate descriptions given with reference to FIG. 2 are omitted.

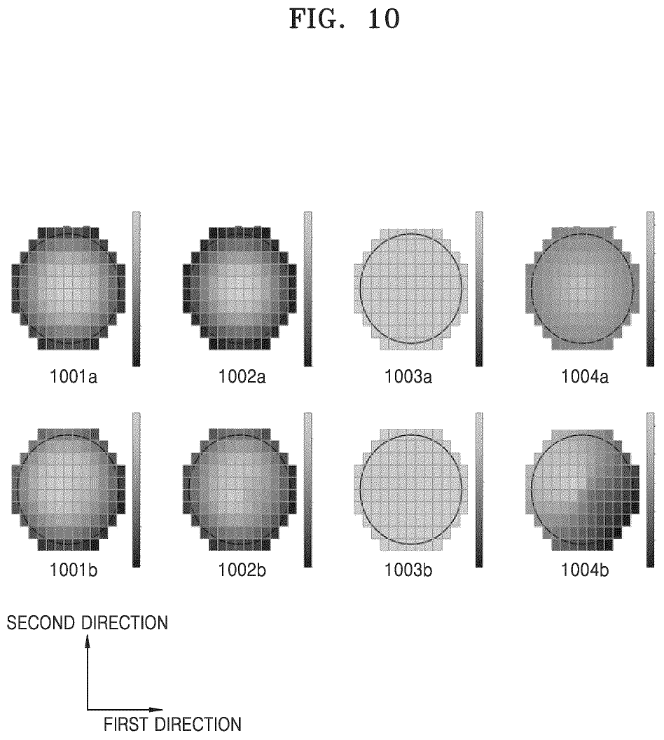

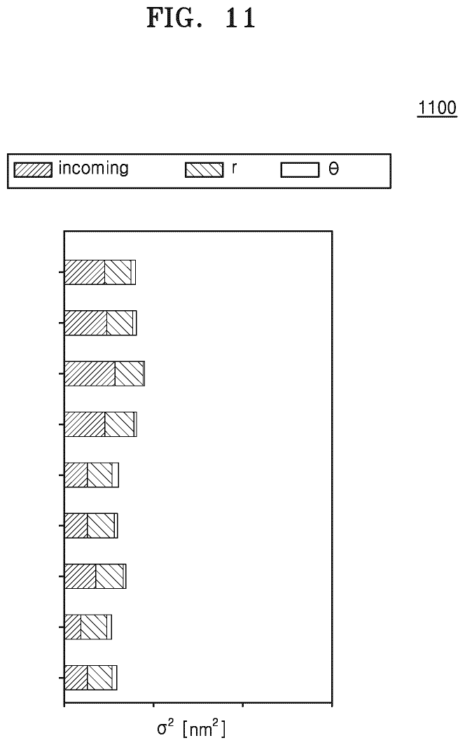

Referring further to FIG. 1, in operation S910, the system 100 may calibrate the wafer map by changing the input data ID, based on a quantized wafer map. In some example embodiments, the wafer map may be configured to be quantified corresponding to any one of a distance from the center of the wafer, an angle from the center of the wafer, and the incoming wafer structure. Detailed embodiments of the quantized wafer map are described below with reference to FIGS. 10 and 11.

In some example embodiments, the distribution dispersion occurring at each location of the wafer may occur due to any one of an apparatus for performing a process simulation of a semiconductor device and a pattern of the wafer. For example, when the distance from the center of the wafer is changed and thus the distribution dispersion occurs, it may be predicted that the distribution dispersion has been generated by an apparatus for performing a process simulation of a semiconductor device, and when an angle from the center of the wafer is changed and the distribution dispersion occurs, it may be predicted that the distribution dispersion occurs due to the pattern of the wafer.

Because the system 100 of inventive concepts may quantify the wafer map, the cause of the occurrence of the distribution dispersion occurring at each location of the wafer may be predicted, and accordingly, the distribution dispersion may be reduced.

FIG. 10 illustrates diagrams of quantified wafer maps according to some example embodiments. FIG. 11 is a diagram of a quantified wafer map 1100 according to some example embodiments.

Referring to FIG. 10, a first wafer map group of wafer maps may include a plurality of wafer maps 1001a, 1002a, 1003a, and 1004a, and mean wafer maps respectively quantified in response to distances from the center of the wafer, and a second wafer map group of wafer maps may include a plurality of wafer maps 1001b, 1002b, 1003b, and 1004b, and mean wafer maps respectively quantified in response to angles from the center of the wafer. Each of the first wafer map group of wafer maps 1001a, 1002a, 1003a, and 1004a and the second wafer map group of wafer maps 1001b, 1002b, 1003b, and 1004b may represent a distribution of the amount of ions and/or radicals corresponding to the coordinates of the wafer, and/or a distribution of the speed of the ions and/or radicals, and the vertical axis (grey scale) of a wafer map may represent a relative amount or relative speed of the ions or radicals corresponding to the coordinates of the wafer. Referring to the first wafer map group of wafer maps 1001a, 1002a, 1003a, and 1004a and the second wafer map group of wafer maps 1001b, 1002b, 1003b, and 1004b, the distribution dispersion may differ depending on the criteria for quantifying the wafer map (for example, the distance from the center of the wafer or the angle from the center of the wafer), and based on the result, the cause of the distribution dispersion may be predicted. For example, the wafer map 1004a and the wafer map 1004b may represent the speed distribution of ions corresponding to the coordinates of the wafer. The wafer map 1004a may have a relatively smaller distribution dispersion than the wafer map 1004b, and based on the result, it may be predicted that the cause of the distribution dispersion includes a pattern of the wafer.

Referring to FIG. 11, the graph 1100 may represent a graph representing a quantified wafer map according to quantified criteria. The vertical axis may represent different wafers, and the horizontal axis may represent distribution dispersion. The wafer map may be quantified according to the distance r from the center of the wafer, the angle θ from the center of the wafer, and the incoming wafer structure. Accordingly, the system 100 of FIG. 1 may identify the cause of the distribution dispersion occurring at each location of the wafer, and may reduce the distribution dispersion according to the cause of the distribution dispersion.

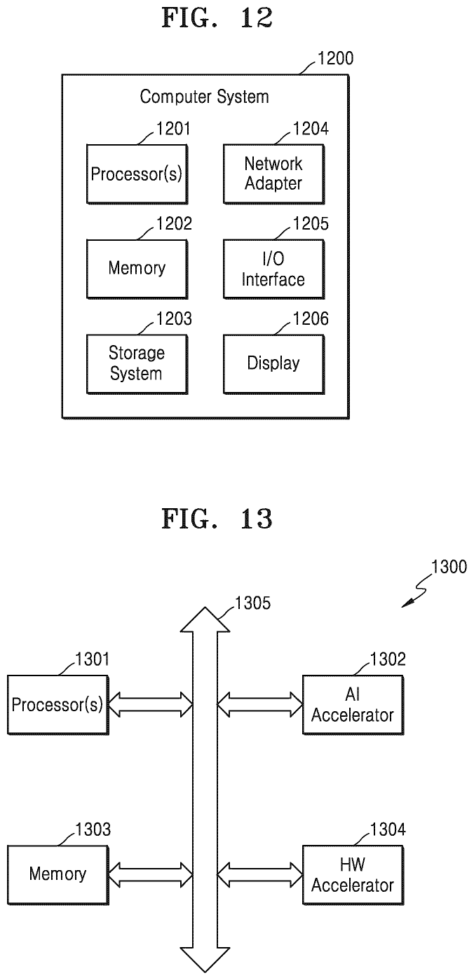

FIG. 12 is a block diagram of a computer system 1200 according to some example embodiments. In some example embodiments, the computer system 1200 of FIG. 12 may generate or train a distribution model based on the measured CDs in the wafer described with reference to the drawings, use the distribution model to generate the wafer map corresponding to the coordinates of the wafer, and thus, perform modeling of the distribution dispersion occurring at each location of the wafer.

The computer system 1200 may be referred to as any system including a general purpose or particular purpose computing system. For example, the computer system 1200 may include one or more of a personal computer, a server computer, a laptop computer, a home appliance, etc. As illustrated in FIG. 12, the computer system 1200 may include at least one processor 1201, a memory 1202, a storage system 1203, a network adapter 1204, an input/output (I/O) interface 1205, and a display 1206.

The at least one processor 1201 may execute a program module including a computer system executable command. The program module may include routines, programs, objects, components, logic, data structures, or the like that perform a particular task or implement a particular abstract data type.

The memory 1202 may include a computer system readable medium in the form of a volatile memory, such as RAM. The at least one processor 1201 may access the memory 1202, and execute instructions loaded on the memory 1202. The storage system 1203 may non-volatilely store information, and in some example embodiments, may include at least one program product including a program module configured to generate or train a distribution model based on the CDs in the wafer measured with reference to the drawings and to generate the wafer map corresponding to the coordinates of the wafer by using the distribution model. The program module may include, as non-limiting examples, an operating system, at least one application, other program modules, and program data.

The network adapter 1204 may provide access to one or more of a local area network (LAN), a wide area network (WAN), and/or a public network (for example, the Internet). The I/O interface 1205 may provide a communication channel with a peripheral device, such as a keyboard, a pointing device, an audio system, etc. The display 1206 may output various pieces of information so that the user may identify the various pieces of information.

In some example embodiments, a method of generating or training a distribution model based on measured CDs in a wafer described with reference to the drawings, and generating a wafer map corresponding to the coordinates of the wafer by using the distribution model may be implemented as a computer program product. The computer program product may include a non-transitory computer-readable medium (or storage medium) including computer-readable program instructions for allowing the at least one processor 1201 to perform image processing and/or training of models. Computer-readable instructions may include, as non-limiting examples, one or more of assembler instructions, instruction set architecture (ISA) instructions, machine instructions, machine-dependent instructions, micro-code, firmware instructions, state setting data, or source code or object code written in at least one programming language.

The computer-readable medium may include any type of medium capable of non-transitorily holding and storing instructions executed by at least one processor 1201 or any instruction-executable device. The computer-readable medium may include an electronic storage device, a magnetic storage device, an optical storage device, an electromagnetic storage device, a semiconductor storage device, or any combination thereof, but is not limited thereto. For example, the computer-readable medium may include one or more of a portable computer diskette, a hard disk, RAM, ROM, EEPROM, flash memory, SRAM, a compact disc (CD), a digital versatile disc (DVD), a memory stick, a floppy disk, a mechanically encoded device such as a punch card, or any combination of these.

Any of the elements described with reference to FIG. 12 may communicate with any other element described with reference to FIG. 12. For example, any clement may engage in one-way and/or two-way and/or broadcast communication with any or all other elements in FIG. 1, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

FIG. 13 is a block diagram of a system 1300 according to some example embodiments. In some example embodiments, a method of generating or training a distribution model based on measured CDs in a wafer according to some example embodiments of inventive concepts, and generating a wafer map corresponding to the coordinates of the wafer by using the distribution model may be executed by the system 1300.

Referring to FIG. 13, the system 1300 may include at least one processor 1301, a memory 1303, an artificial intelligence (AI) accelerator 1302, and a hardware (HW) accelerator 1304, and the at least one processor 1301, the memory 1303, the AI accelerator 1302, and the HW accelerator 1304 may communicate with each other via a bus 1305. In some example embodiments, the at least one processor 1301, the memory 1303, the AI accelerator 1302, and the HW accelerator 1304 may also be included in one semiconductor chip. In addition, in some example embodiments, at least two of the at least one processor 1301, the memory 1303, the AI accelerator 1302, and the HW accelerator 1304 may also be included in each of two or more semiconductor chips mounted on a board.

The at least one processor 1301 may execute instructions. For example, the at least one processor 1301 may also execute an operating system by executing instructions stored in the memory 1303 or may also execute applications running on the operating system. In some example embodiments, the at least one processor 1301 may instruct tasks of the Al accelerator 1302 and/or the HW accelerator 1304 by executing instructions, and may also obtain a result of performing the task from the AI accelerator 1302 and/or the HW accelerator 1304. In some example embodiments, the at least one processor 1301 may include an application specific instruction set processor (ASIP) customized for a specific use, and may also support a dedicated instruction set.

The memory 1303 may have an arbitrary structure for storing data. For example, the memory 1303 may also include a volatile memory device, such as one or more of dynamic random access memory (RAM) (DRAM), SRAM, and/or may include a non-volatile memory device, such as one or more of flash memory and resistive RAM (RRAM). The at least one processor 1301, the AI accelerator 1302, and the HW accelerator 1304 may store data in the memory 1303, or read the data from the memory 1303.

The Al accelerator 1302 may be referred to as hardware designed for AI applications. In some example embodiments, the AI accelerator 1302 may include one or more of a neural processing unit (NPU) for implementing a neuromorphic structure, may generate output data by processing input data provided by the at least one processor 1301 and/or the HW accelerator 1304, and may provide output data to the at least one processor 1301 and/or the HW accelerator 1304. In some example embodiments, the AI accelerator 1302 may be programmable, and may be programmed by the at least one processor 1301 and/or the HW accelerator 1304.

The HW accelerator 1304 may be referred to as hardware designed to perform a particular task at a high speed. For example, the HW accelerator 1304 may be designed to perform data transform at a high speed, such as demodulation, modulation, encoding, and decoding. The HW accelerator 1304 may be programmable, and may be programmed by at least one processor 1301 and/or the HW accelerator 1304.

In some example embodiments, the AI accelerator 1302 may execute the machine learning models described above with reference to the drawings (for example, any one of the plasma model 110, the distribution model 120, and the etch model 130 in FIG. 1). The AI accelerator 1302 may execute a machine learning model used for generating or training a distribution model based on measured CDs in a wafer described with reference to the drawings, and generating the wafer map corresponding to the coordinates of the wafer by using the distribution model. The AI accelerator 1302 may generate an output including useful information by processing input parameters, feature maps, etc. In addition, in some example embodiments, at least some of the models executed by the AI accelerator 1302 may be executed by the at least one processor 1301 and/or the HW accelerator 1304.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts has been particularly shown and described with reference to embodiments thereof, it will be understood that various change in form and details may be made therein without departing from the spirit and scope of the following claims. Further, example embodiments are not necessarily mutually exclusive with one another. For example, some example embodiments may include one or more features described with reference to one or more figures, and may also include one or more other features described with reference to one or more other figures.

What is claimed is:

1. A method of performing a process simulation of a semiconductor device, the method comprising:
computing a reaction of input data by using a plasma model, and based on the computed reaction, generating a first output including first flux and first energy;
generating a second output including second flux and second energy, the generating the second output based on the first output and coordinates of a wafer, the generating the second output by using a distribution model; and
generating a wafer map based on the second output and a structure of the wafer, the generating the wafer map by using an etch model, wherein
the second flux comprises flux corresponding to each of the coordinates of the wafer, and
the second energy comprises energy corresponding to each of the coordinates of the wafer.

2. The method of claim 1, wherein the wafer map comprises a distribution of the second flux, a distribution of the second energy, and critical dimensions (CDs) corresponding to each of the coordinates of the wafer.

3. The method of claim 1, wherein the coordinates of the wafer comprise any one of coordinates corresponding to a cartesian coordinate system or coordinates corresponding to a polar coordinate system.

4. The method of claim 1, further comprising:
generating the distribution model,
wherein the generating of the distribution model comprises,
computing third flux and third energy for outputting a first output CD by using the etch model,
computing the second output for outputting a second output CD by using an algorithm, based on the third flux, the third energy, and the coordinates of the wafer, and
generating the distribution model which is a function configured to output the second output with the third flux, the third energy, and the coordinates of the wafer as an input, wherein
the first output CD comprises at least one of an average CD of the wafer and the CD corresponding to a center of the wafer, and
the second output CD comprises the CD corresponding to the coordinates of the wafer.

5. The method of claim 4, wherein the algorithm comprises an algorithm to compute the second output to reduce an objective function by receiving the third flux, the third energy, and the coordinates of the wafer as input, and changing the third flux and the third energy.

6. The method of claim 4, wherein the function comprises a function generated by using at least one of an artificial neural network or symbolic regression (SR).

7. The method of claim 1, further comprising:
training the distribution model,
wherein the training of the distribution model comprises,
receiving measured CDs corresponding to the coordinates of the wafer, and
training the distribution model based on a training set by using the plasma model and the etch model, and
wherein the training set comprises the input data, the coordinates of the wafer, and CDs corresponding to the coordinates of the wafer.

8. The method of claim 1, wherein the wafer map is configured to be quantified in response to any one of a distance from a center of the wafer, an angle from the center of the wafer, and a structure of the wafer.

9. The method of claim 8, further comprising:
calibrating the wafer map by changing the input data based on the quantified wafer map.

10. A system comprising:
at least one processor; and
a non-transitory storage medium storing machine-readable instructions which, when executed by the at least one processor, cause the system to execute a method of performing a process simulation of a semiconductor device,
wherein the method of performing the process simulation of the semiconductor device comprises,
outputting first flux and first energy, the outputting first flux and first energy based on a reaction of input data including gas, temperature, and a voltage;
outputting second flux and second energy, the second flux and second energy corresponding to coordinates of a wafer, the outputting the second flux and second energy based on the first flux, the first energy, and the coordinates of the wafer, the outputting the second flux and second energy by using a distribution model; and
generating a wafer map based on the second flux, the second energy, and a structure of the wafer, the generating the wafer map by using an etch model, and
wherein the wafer map comprises critical dimensions (CDs) corresponding to a distribution of the second flux, a distribution of the second energy, and the coordinates of the wafer.

11. The system of claim 10,
wherein the method of performing the process simulation of the semiconductor device comprises:
computing third flux and third energy for outputting a first output CD by using the etch model;
computing the second output and the second energy for outputting a second output CD by using an optimization algorithm, based on the third flux, the third energy, and the coordinates of the wafer; and
generating the distribution model which is a function configured to output the second flux and the second energy with the third flux, the third energy, and the coordinates of the wafer as an input,
wherein the first output CD comprises any one of an average CD of the wafer and the CD corresponding to a center of the wafer, and
wherein the second output CD comprises the CD corresponding to the coordinates of the wafer.

12. The system of claim 11, wherein
the optimization algorithm comprises an algorithm for computing the second flux and the second energy to reduce an objective function by receiving the third flux, the third energy, and the coordinates of the wafer as an input, and changing the third flux and the third energy.

13. The system of claim 10, wherein
a method of performing the process simulation of the semiconductor device comprises:
receiving measured CDs corresponding to the coordinates of the wafer; and
training the distribution model based on a training set including the input data, the coordinates of the wafer, and CDs corresponding to the coordinates of the wafer.

14. The system of claim 10, wherein
the wafer map is configured to be quantified in response to any one of a distance from a center of the wafer, an angle from the center of the wafer, and a structure of the wafer.

15. The system of claim 10, wherein
the coordinates of the wafer comprise any one of coordinates corresponding to a cartesian coordinate system and coordinates corresponding to a polar coordinate system.

16. A storage medium comprising:
a non-transitory computer-readable recording medium including machine-readable instructions, wherein
the instructions are configured such that, when executed by at least one processor, the at least one processor executes a method of performing a process simulation of a semiconductor device,
wherein the method of performing the process simulation of the semiconductor device comprises:
outputting first flux and first energy based on a reaction of input data including gas, temperature, and a voltage;
outputting second flux and second energy corresponding to coordinates of a wafer, based on the first flux, the first energy, and the coordinates of the wafer, by using a distribution model; and
generating a wafer map based on the second flux, the second energy, and a structure of the wafer by using an etch model, and
wherein the wafer map comprises critical dimensions (CDs) corresponding to a distribution of the second flux, a distribution of the second energy, and the coordinates of the wafer.

17. The storage medium of claim 16, wherein the method of performing the process simulation of the semiconductor device further comprises:
computing third flux and third energy for outputting a first output CD by using the etch model;
computing the second output and the second energy for outputting a second output CD by using an algorithm, based on the third flux, the third energy, and the coordinates of the wafer; and
generating the distribution model which includes a function configured to output the second flux and the second energy with the third flux, the third energy, and the coordinates of the wafer as an input, wherein
the first output CD comprises any one of an average CD of the wafer and the CD corresponding to a center of the wafer, and
the second output CD comprises the CD corresponding to the coordinates of the wafer.

18. The storage medium of claim 16, wherein the method of performing the process simulation of the semiconductor device further comprises:
receiving measured CDs corresponding to the coordinates of the wafer; and
training the distribution model based on a training set including the input data, the coordinates of the wafer, and CDs corresponding to the coordinates of the wafer.

19. The storage medium of claim 16, wherein
the wafer map is configured to be quantified in response to any one of a distance from a center of the wafer, an angle from the center of the wafer, and a structure of the wafer.

20. The storage medium of claim 16, wherein
the coordinates of the wafer comprise any one of coordinates corresponding to a cartesian coordinate system and coordinates corresponding to a polar coordinate system.
